(19) United States
(12) Patent Application Publication
(10) Pub. No.: US 2026/0044295 A1
(43) Pub. Date: Feb. 12, 2026

(54) E-Ink Display Device with Magnetic Backing and App-Controlled Calendar for Daily Event Scheduling, Meal and Nutrition Planning, and Medication Management

(71) Applicant: Evan Chaim Litwack, Silver Spring, MD (US)

(72) Inventor: Evan Chaim Litwack, Silver Spring, MD (US)

(21) Appl. No.: 18/799,316

(22) Filed: Aug. 9, 2024

(51) Int. Cl. G06F 3/14; G06F 3/0362

(52) U.S. Cl. CPC G06F 3/14; G06F 3/0362

(57) ABSTRACT

The present invention relates to an e-ink display device designed for versatile placement and enhanced convenience. The device can be freestanding, magnetically attached to metallic surfaces, or affixed with adhesive strips. It displays hourly events, including sunrise and sunset times, as well as detailed information on meals, medication reminders, to-do lists, and other scheduled activities. A rotating control allows users to switch between detailed views, while a power button, analog switch for battery preservation, and backlight button offer additional functionality. An internal microcontroller manages the display and inputs, with clock and calendar settings synchronized via an app to ensure accurate information. The design combines ease of use with functionality, providing an organized and accessible planner for daily meals, medication, and activities.

### BACKGROUND OF INVENTION

### 1. Field of the Invention

The present invention relates to electronic display technologies and, more specifically, to an e-ink display device designed for scheduling, task management, and medication reminders. This invention falls within the realm of user interface design and electronic devices intended for daily use.

### 2. Description of Related Art

Traditional digital displays used for scheduling and task management, such as electronic calendars and organizers, have several limitations. These devices often suffer from poor visibility in varying lighting conditions, such as bright sunlight or dim environments. Additionally, existing solutions may have limited battery life, requiring them to be plugged in at all times, which necessitates frequent recharging or maintenance. Furthermore, these devices often rely on continuous internet connectivity to maintain the user experience.

Current devices typically offer over-customization options for displaying different types of information, leading to clutter and the overuse of key information. Their placement and portability can be restricted by design constraints. Moreover, managing medication schedules and daily activities with existing devices can be cumbersome and inefficient, lacking integrated reminders and detailed information. The controls on these devices can be difficult to use for individuals with accessibility needs, as they often rely on small buttons or touch screens.

### 3. Need for the Invention

There is a clear need for an electronic display device that addresses these limitations. An ideal solution would provide improved readability and power efficiency, be versatile in placement, allow for battery recharging without removing the device, and offer a user-friendly interface with customizable display options that accommodate users with accessibility needs. The device should also integrate seamlessly with digital calendars to provide real-time updates and offer effective management of medication schedules and daily activities.

The present invention meets these needs by incorporating e-ink technology for superior readability and low power consumption, a microcontroller for efficient operation and control, and analog controls that focus on vital medication and meals, power control, and backlight functions. Additionally, it features a versatile mounting system and an intuitive user interface. This invention enhances the user experience by integrating with digital calendars and providing comprehensive medication management features.

### SUMMARY OF INVENTION

### 4. Overview and Operation

The present invention relates to an innovative e-ink display device designed to assist individuals in managing their daily schedules, tasks, and medication reminders. This device is equipped with an e-ink display that ensures high readability and low power consumption. It includes a control panel with various analog buttons for operating the device, a backlight for improved visibility, and a removable battery for easy charging. A switch is provided for cutting power to maximize battery life. The device is lightweight, magnetized, and can be freestanding or affixed to various surfaces, making it versatile for use in different environments such as home, office, long-term care, residential, or medical facilities.

The device operates by connecting to the user's calendar via an app, ensuring that accurate and up-to-date information is displayed. The app captures user settings and synchronizes the device with the user's calendar, providing real-time updates on events, tasks, and reminders. The display can be customized to show various types of information, including the date, time, weather, daily activities by the hour, medication reminders, and meal plans. Users can switch between different display modes using the rotating control on the device, allowing them to view detailed medication and meal plans.

### 5. Advantages

The e-ink display device offers several advantages over existing solutions:
High Readability and Low Power Consumption: The use of e-ink technology ensures that the display is easily readable even in bright light conditions while consuming minimal power.
Versatile Placement: The device's lightweight design, magnetized backing, and compatibility with adhesive strips allow it to be placed on various surfaces, including refrigerators and walls.
User-Friendly Interface: The control panel with dedicated buttons for different functions makes it easy to operate the device. The backlight button ensures that the display is visible even in low-light conditions.
Customizable Display: The device can display a wide range of information tailored to the user's needs, including calendar events, tasks, medication reminders, and meal plans.
App Integration: The device synchronizes with the user's calendar via an app, ensuring that the displayed information is always up-to-date.
Removable Battery: The battery can be easily removed and replaced, ensuring that the device remains functional without requiring frequent recharges.
Enhanced Medication Management: The device helps users manage their medications by providing timely reminders and detailed information on dosages and instructions.
Detailed Display Modes: Users can switch between different display modes using the rotating control on the device, allowing them to view detailed medication and meal plans.
Power Switch Feature: The device includes a power switch that can shut off the power, freezing the screen to conserve battery life while still displaying the last shown information.

By integrating these features, the e-ink display device offers a comprehensive solution for managing daily schedules and medication reminders, enhancing user convenience and efficiency.

### BRIEF DESCRIPTION OF THE DRAWINGS

### 6. Overview of the Drawings

The drawings provided illustrate various aspects of the e-ink display device as described in the patent application. Each figure provides a different view or detail of the device to support the understanding of its structure, functionality, and operation. The following descriptions correspond to the respective figures and highlight the key components and features depicted.

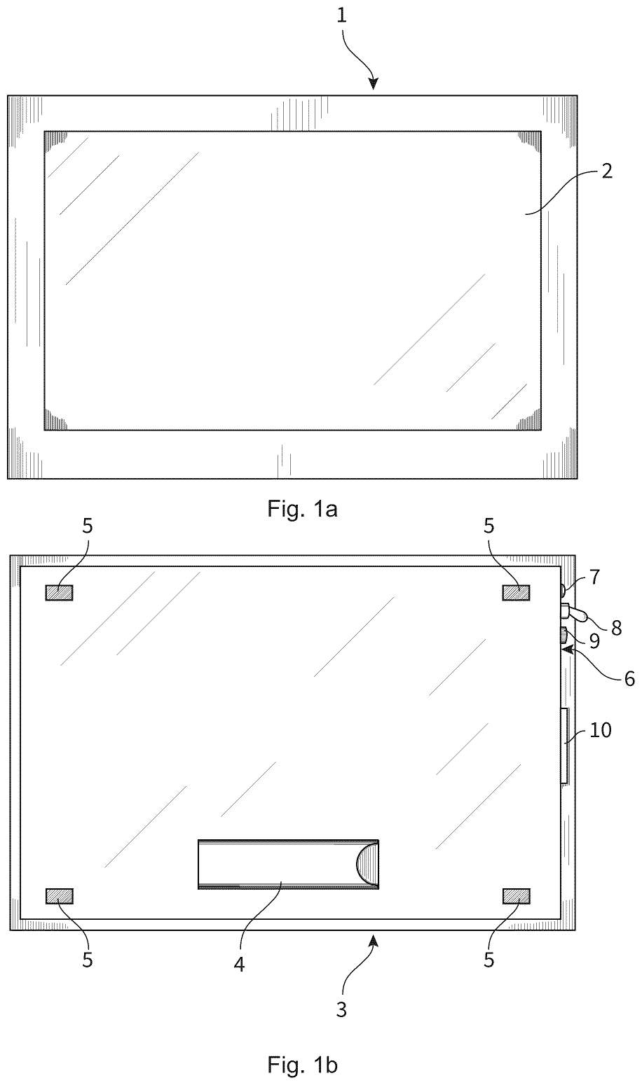

FIG. 1a is a front view of the e-ink display device, illustrating the main components visible from the front.

FIG. 1b is a back view of the e-ink display device, showing the stand, magnets, button control panel, backlight button, power on/off switch, rotating control, and removable battery.

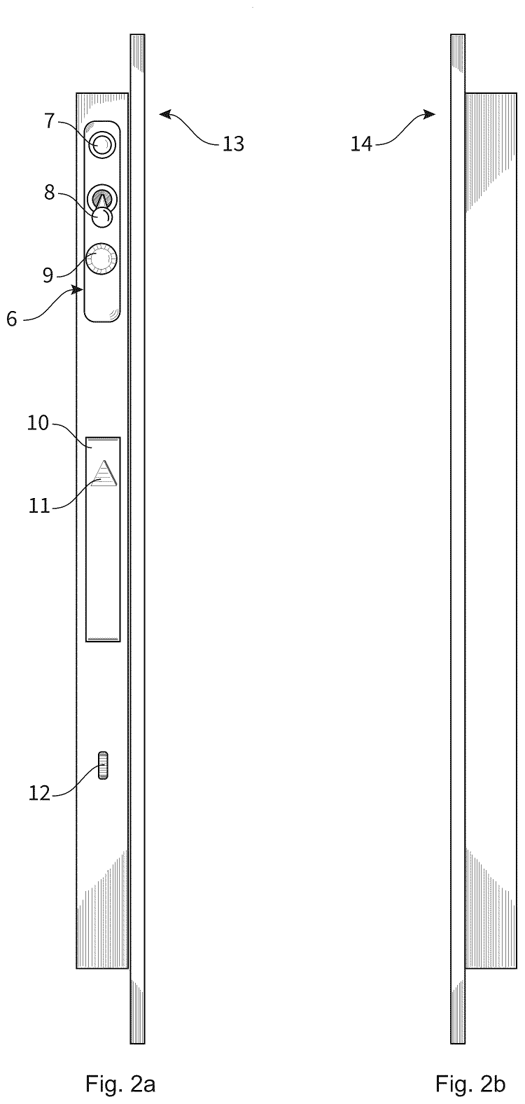

FIG. 2a is a left side view of the e-ink display device, depicting the button control panel, backlight button, power on/off switch, rotating control, removable battery, raised button for battery extension, and micro USB charging port.

FIG. 2b is a right side view of the e-ink display device, providing details on the right side configuration.

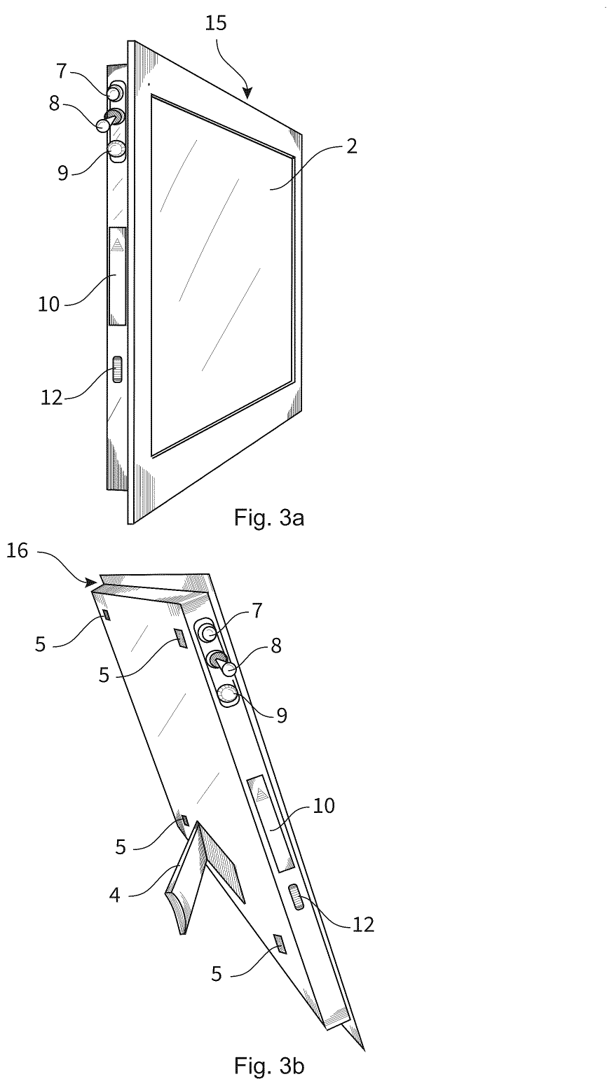

FIG. 3a is a front perspective view of the e-ink display device, highlighting the e-ink screen, backlight button, power on/off switch, rotating control, removable battery, and micro USB charging port.

FIG. 3b is a back perspective view of the e-ink display device, showing the stand, magnets, backlight button, power on/off switch, rotating control, removable battery, and micro USB charging port.

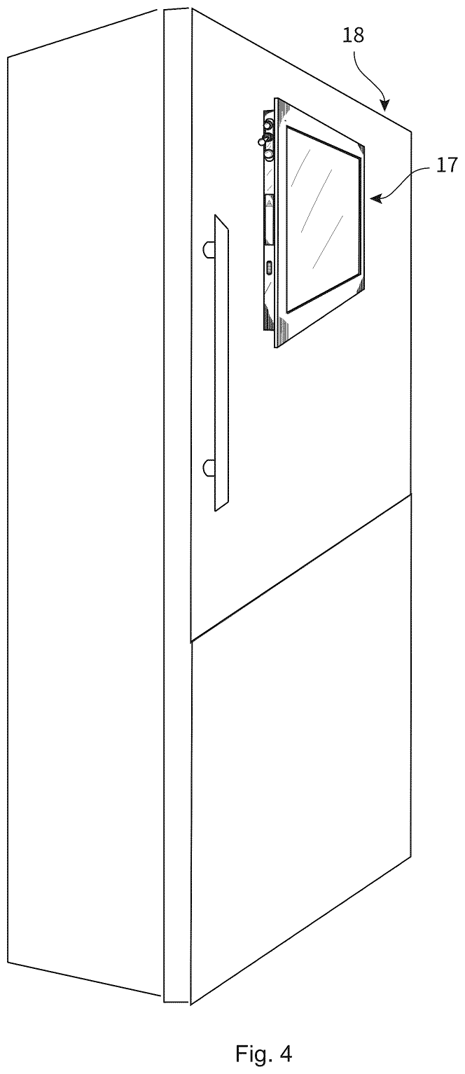

FIG. 4 illustrates the e-ink display device mounted on a refrigerator using the magnets.

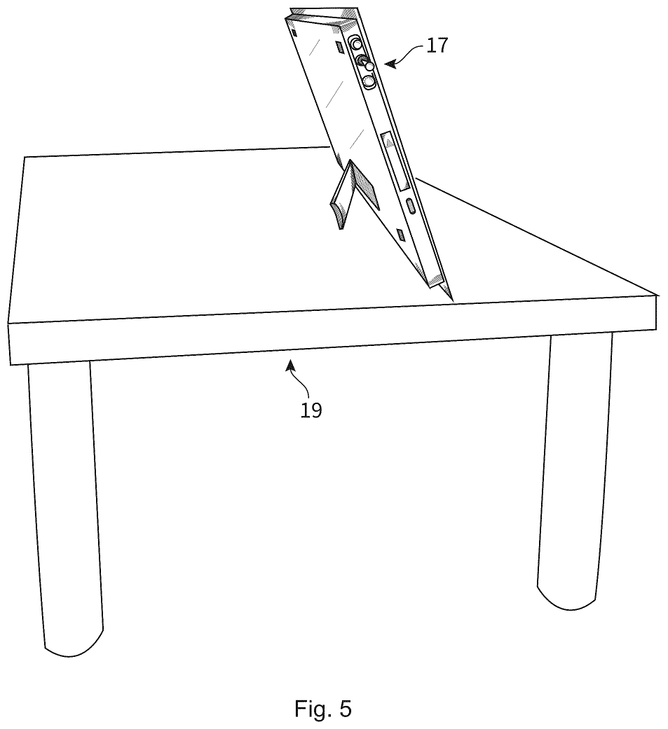

FIG. 5 shows the e-ink display device positioned on a table in a freestanding configuration.

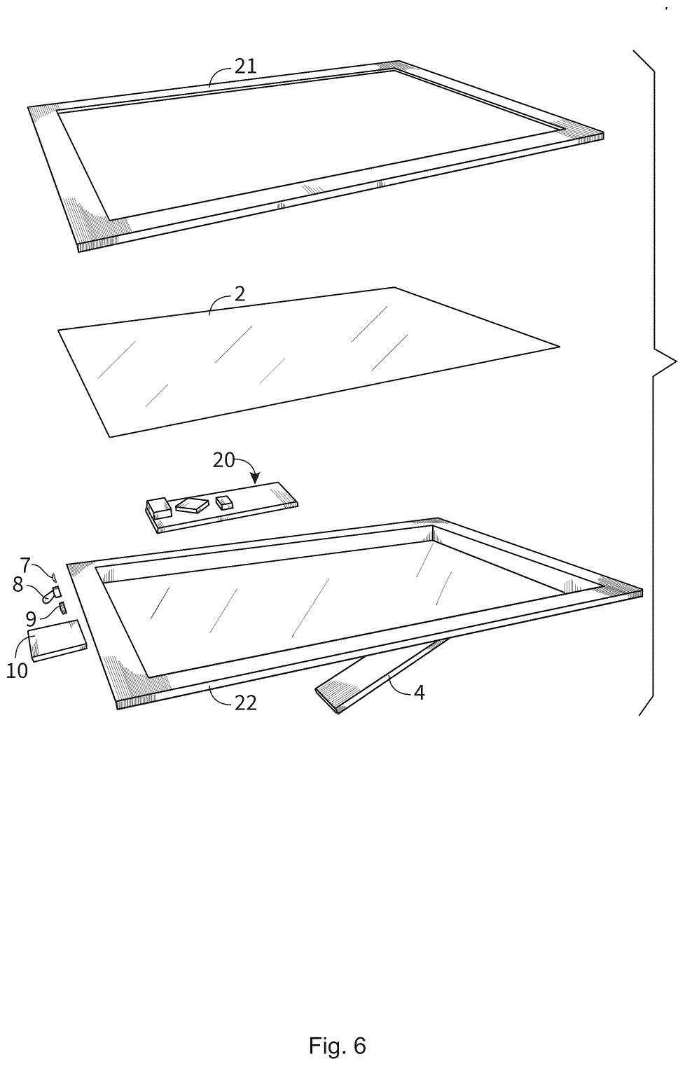

FIG. 6 is an exploded view of the e-ink display device, detailing the front panel with e-ink display, microcontroller, back panel, backlight button, power on/off switch, rotating control, removable battery, and stand.

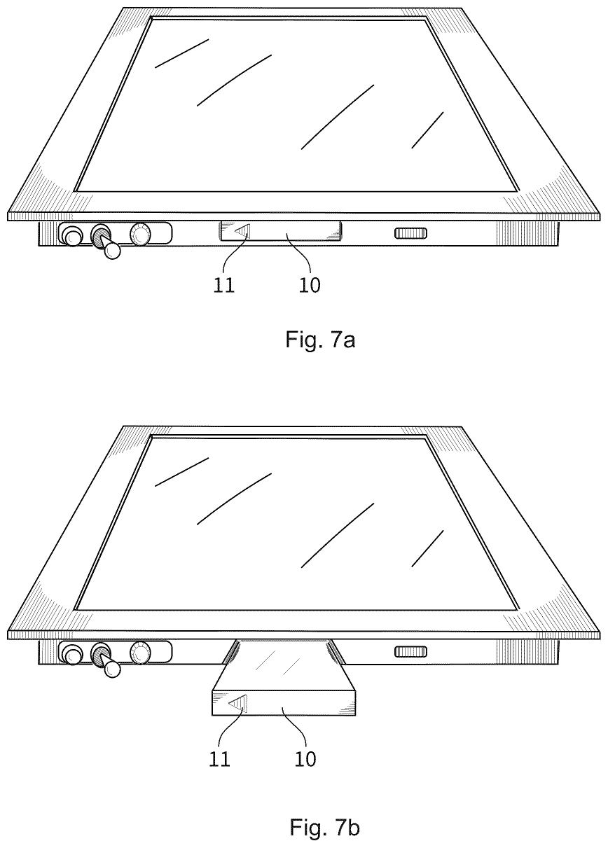

FIG. 7a depicts the battery insertion process with the battery inserted and the raised button in place.

FIG. 7b illustrates the battery removal process after pressing the raised button.

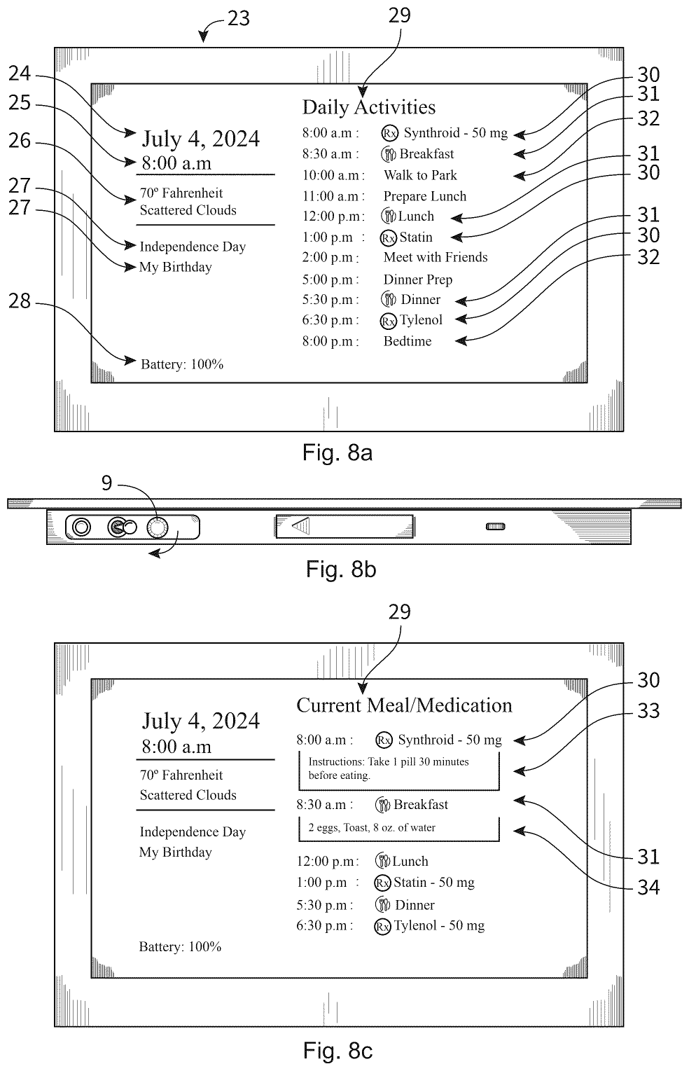

FIG. 8a shows the default state of the e-ink display device, including date, time, weather, all-day events, battery level, and daily activities.

FIG. 8b is a side view showing the rotating control mechanism that changes display state.

FIG. 8c demonstrates the display after the state change, showing current meal and medication details, dosage instructions, and meal plan.

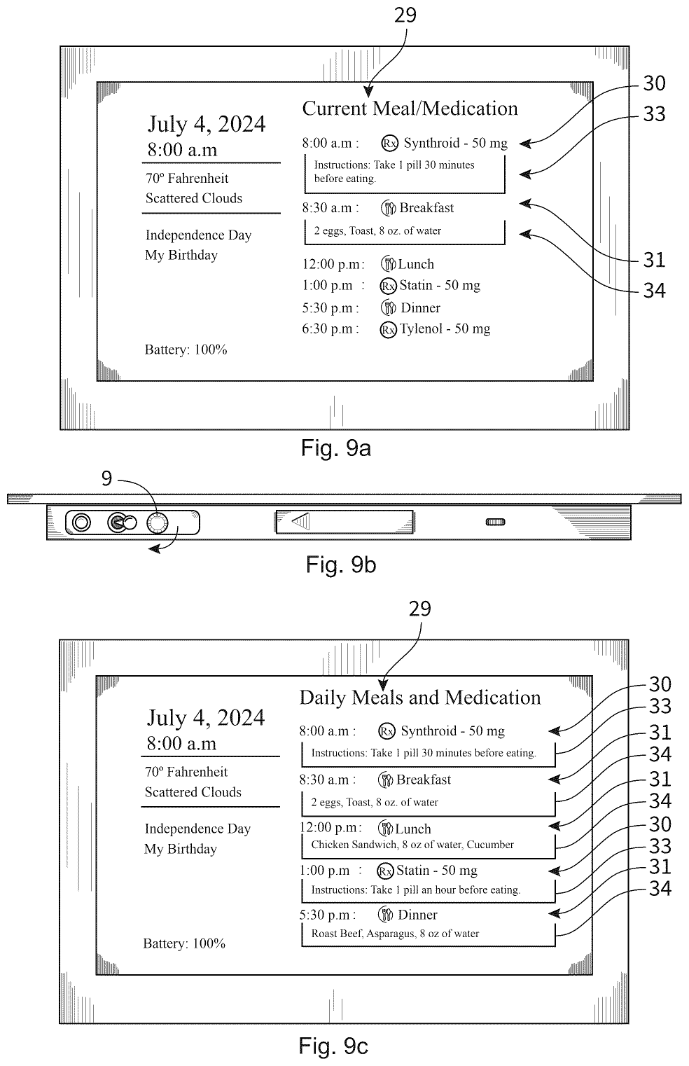

FIG. 9a replicates the display state from FIG. 8c, showing current meal and medication details, dosage instructions, and meal plan prior to change of state.

FIG. 9b is a side view showing the rotating control mechanism that changes the display state.

FIG. 9c demonstrates the display after the state change, showing daily meals and medication details, dosage instructions, and meal plan for the entire day.

### DETAILED DESCRIPTION OF THE INVENTION

### 7. Introduction

The present invention relates to an innovative e-ink display device designed to assist individuals in managing their daily schedules, including events, tasks, meal and medication reminders. This device is lightweight, magnetized, and can be freestanding or affixed to various surfaces, making it versatile for different environments such as home, office, long-term care, residential, or medical facilities. The device integrates with a user's calendar via an app to provide real-time updates and display essential information, including sunrise and sunset times.

The design includes a backlight for improved visibility, a removable battery for easy maintenance, and buttons for intuitive operation. The device also features a power on/off switch that can shut off the power, freezing the screen to conserve battery life while still displaying the last shown information. Furthermore, the device includes accessibility features such as large, easy-to-use analog controls and a clear, customizable display to accommodate users with varying needs.

The following detailed description, along with the accompanying drawings, provides a comprehensive understanding of the device's structure, functionality, and various embodiments, highlighting its high readability, low power consumption, versatile placement options, and user-friendly interface.

### 8. Detailed Description

FIG. 1a shows the front view of the e-ink display device [1]. The primary component is the e-ink display [2], which presents the user's daily schedule, including events, tasks, and other pertinent information. The display utilizes e-ink technology, ensuring high readability and low power consumption.

FIG. 1b illustrates the back view of the e-ink display device [3]. This view highlights several essential features, including the stand [4], which can be extended to allow the device to stand freely on a flat surface. Additionally, magnets [5] are positioned on the back, enabling the device to attach securely to a refrigerator or other magnetic surfaces. The button control panel [6] is also shown, which includes various buttons for operating the device. The backlight button [7] is provided to activate the backlight, illuminating the display for better visibility in low-light conditions. Furthermore, the power on/off switch [8] allows the user to turn the device on and off. The device is also equipped with a rotating control [9], enabling the user to switch between different display modes. Lastly, the removable battery [10] is housed in a compartment for easy access and replacement.

FIG. 2a presents the left side view of the device [13], showcasing the placement of the button control panel [6], backlight button [7], power on/off switch [8], change of screen state rotating control [9], and removable battery [10]. Additionally, it includes the raised button [11] to trigger battery extension and charging, and the micro USB charging port [12] for alternative charging and active power.

FIG. 2b shows the right side view of the device [14], indicating the placement and design of the right side.

FIGS. 3a and 3b provide perspective views of the e-ink display device in different environments:
FIG. 3a illustrates a front perspective view of the device [15], where the e-ink screen [2] is prominently displayed. The backlight button [7], power on/off switch [8], change of screen state rotating control [9], removable battery [10], and micro USB charging port [12] are also visible, showcasing the key functional components accessible from the front.
FIG. 3b offers a back perspective view of the device [16], highlighting the stand [4], which allows the device to be placed securely on flat surfaces. The magnets [5] on the back are shown, enabling attachment to metallic surfaces. The backlight button [7], power on/off switch [8], change of screen state rotating control [9], removable battery [10], and micro USB charging port [12] are also visible from this angle, illustrating their placement on the device.

FIG. 4 illustrates the device [17] affixed to a refrigerator [18] via the magnets [5].

FIG. 5 demonstrates the device [17] in a freestanding position on a table [19].

FIG. 6 is an exploded view of the e-ink display device, providing a detailed illustration of its internal components. The front panel [21] is shown, which houses the e-ink display [2]. Positioned behind the display is the microcontroller [20], responsible for managing the device's functions. The back panel [22] is depicted, which forms the outer casing of the device. Also visible are the backlight button [7] and the power on/off switch [8], both integral for user interaction. The change of screen state rotating control [9] is included in this view, allowing the user to switch between various display modes. Additionally, the removable battery [10] is shown, which provides power to the device. Finally, the stand [4] is displayed, which supports the device when placed on flat surfaces.

FIGS. 7a and 7b illustrate the battery insertion and removal process:
FIG. 7a shows the device with the battery [10] inserted and the raised button [11].
FIG. 7b shows the battery partially removed after the raised button [11] is pushed.

FIGS. 8a-8c provide detailed views of the device's display and its interaction with the user:
FIG. 8a shows the front view of the device in its default state [23], displaying the date [24], current time [25], weather [26], all-day events [27], battery level [28], display header [29] and daily activities by the current time [25] such as medications [30], meals [31], and general activities [32].
FIG. 8b shows the side view of the device, with a rotation arrow indicating that the user can rotate the change of screen state rotating control [9]. Upon rotation, the display changes state.
FIG. 8c shows the display after the state change, with the current medication [30] and meal [31] for the hour displayed, along with detailed information regarding dosage and medication instructions [33], and meal details including the meal plan [34] and the display header [29] changed to reflect.

FIGS. 9a-9c Focus on the detailed views of the display changes:
FIG. 9a replicates the state from FIG. 8c, showing the current medication [30], and meal [31], dosage information [33], and meal plan details [34] and display header [29].
FIG. 9b shows the side view again with a rotation arrow indicating another dial rotation of the change of screen state rotating control [9].
FIG. 9c shows the display changes to show daily meals and medications for the entire day, displaying multiple instances of medications [30], meals [31], dosage information [33], meal details and plans [34] and the display header [29] changed to reflect the new state.

1: An e-ink display device comprising an e-ink display screen, a housing containing: a pivotally attached stand configured to extend from a recessed position and support the device at an inclined angle on a flat surface; embedded magnets positioned on the rear surface, the magnets configured to enable non-permanent, removable attachment to metallic surfaces with sufficient holding force to support the device; a power source, a control system for managing the display and one or more inputs, wherein the display device performs daily event scheduling, including the display of hourly events, meals, and medication management.

2: The e-ink display device of claim 1, wherein the power source comprises an internal battery and a power on/off switch.

3: The e-ink display device of claim 2, wherein the internal battery is housed in a compartment designed for easy removal and replacement.

4: The e-ink display device of claim 1, wherein the housing unit includes adhesive strip compatibility for attachment to non-magnetic surfaces.

5: The e-ink display device of claim 1, further comprising a rotating control for changing the display to show detailed information on medication and meal plans, as well as daily events.

6: The e-ink display device of claim 1, further comprising a backlight button to illuminate the screen.

7: The e-ink display device of claim 1, wherein the control system includes a microcontroller for managing the display and inputs from control buttons.

8: The e-ink display device of claim 1, wherein the control system includes an internal clock and calendar software for timekeeping and event scheduling, managed via an app, including medication reminders.

9: The e-ink display device of claim 8, wherein the internal clock and calendar software includes preset events such as sunrise and sunset times.

10: The e-ink display device of claim 1, wherein the e-ink display screen provides low power consumption and high visibility.

11: The e-ink display device of claim 8, further comprising a wireless connectivity module for synchronization with the app.

12: The e-ink display device of claim 1, further comprising large, accessible analog buttons for basic operations.

13: The e-ink display device of claim 8, wherein the app synchronizes with the user's digital calendar to provide real-time updates and accurate information display.

14: The e-ink display device of claim 1, wherein the display includes a section specifically for medication management, showing detailed information on dosage and instructions.

15: The e-ink display device of claim 1, wherein the display includes a section specifically for meal planning, showing meal details and nutritional information.

16: The e-ink display device of claim 1, further comprising a visual alert system for reminders related to meals and medications.

17: The e-ink display device of claim 1, wherein the embedded magnets are positioned proximate to the four corners of the rear surface of the housing to distribute holding force.

18: The e-ink display device of claim 1, wherein the e-ink display is configured to retain information continuously with minimal power draw, enabling multi-day or multi-week uninterrupted visual accessibility without recharge.
